(19) United States
(12) Patent Application Publication
(10) Pub. No.: US 2013/0169679 A1
(43) Pub. Date: Jul. 4, 2013

(54) VEHICLE IMAGE DISPLAY SYSTEM AND CORRECTION METHOD THEREOF

(71) Applicants: YI-FENG SU, CHANGHUA COUNTY (TW); JIN-YI CHEN, CHANGHUA COUNTY (TW); CHIH-BIN CHIANG, CHANGHUA COUNTY (TW)

(72) Inventors: YI-FENG SU, CHANGHUA COUNTY (TW); JIN-YI CHEN, CHANGHUA COUNTY (TW); CHIH-BIN CHIANG, CHANGHUA COUNTY (TW)

(73) Assignee: AUTOMOTIVE RESEARCH & TEST CENTER, CHANGHUA COUNTY (TW)

(21) Appl. No.: 13/340,904

(22) Filed: Dec. 30, 2011

(51) Int. Cl. G09G 5/377

(52) U.S. Cl. 345/633

(57) ABSTRACT

A vehicle image display system and correction method thereof, applicable to a vehicle to perform vehicle information display, comprising following steps, fetch a front road image; obtain positions of a lane marking and an obstacle in front based on said front road image; after correction, calculate display information of said positions of said lane markings and said obstacles in front, to be overlapped with images of an actual traffic lane; utilize a motor control unit to adjust focal length or inclination angle of a projector unit, or inclination angle of a viewable panel, to produce overlap error correction values to correct said display information. Said projector unit projects large area display information overlapped entirely with images of said actual traffic lane onto said viewable panel or windshield, so that a driver can obtain vehicle driving information, to raise vehicle driving safety.

### BACKGROUND OF THE INVENTION

1. Field of the Invention

The present invention relates to vehicle image display system and correction method thereof, and in particular to a vehicle image display system and correction method thereof, that is capable of projecting large area display information overlapped entirely with image of the actual road.

2. The Prior Arts

Along with the growth of economy and advance of technology, the number of motor vehicles is increasing rapidly. In this regard, traffic accidents also increase rapidly, for which over-speed collision is the main reason and occupies a rather high percentage. In order to raise the safety of driving vehicle, Head Up Display (HUD) has become a basic equipment for most of the vehicles, and that is capable of projecting information displayed ordinarily on an instrument panel onto the windshield of a vehicle, so that in driving a vehicle, a driver is able to view and know the conditions of the road through looking at the information on the windshield, without the need to lower his head to look at the instrument panel, since that is the main reason to cause traffic accidents frequently.

Moreover, refer to FIG. 1 for a schematic diagram of a Head Up Display (HUD) according to the prior art. As shown in FIG. 1, for an advanced version of Head Up Display (HUD), various vehicle driving information 10, such as navigation and alarm information can be displayed on the windshield 12, that includes vehicle driving speed, small arrow navigation guide, front vehicle information (such as distance between vehicles), and traffic lane information (width of traffic lane, vehicle deviation amount). When the distance between the vehicle and the vehicle in front is getting too close, or the driver is driving too fast, the Head Up Display (HUD) could issue warning to alarm the driver to slow down to avoid traffic accidents.

However, to place such a Head Up Display (HUD) in a rather narrow and limited space inside the vehicle, the Head Up Display (HUD) must be miniaturized, so it is only capable of small area display. Therefore, from the information displayed and the road actually seen, the driver still can not determine the actual road conditions intuitively and accurately. In addition, the driver is not able to have a complete grasp of the distance to the vehicle in front, width of the traffic lane and routes available to be taken, due to field depth vision angle variations, caused by various factors such as height and seating gesture of the driver, his distance to the windshield, or the vehicle driving trajectory.

Therefore, presently, the design and performance of the Head Up Display (HUD) is not quite satisfactory, and it has much room for improvements.

### SUMMARY OF THE INVENTION

In view of the shortcomings of the prior art, the present invention provides a vehicle image display system and correction method thereof, so as to overcome the problems of the prior art.

A major objective of the present invention is to provide a vehicle image display system and correction method thereof, which integrates the images of the road in front of the vehicle, and projects the display information overlapped with the actual road images onto the windshield, so that visually, the driver feels that he is driving on the actual road, and the obstacle in front is clearly marked, such that the information is presented to the driver real-time for him to have a precise grasp of the actual road conditions to raise driving safety.

Another objective of the present invention is to provide a vehicle image display system and correction method thereof, that is capable of correcting the display information based on the dynamic motions of the driver and the vehicle, to correct and compensate the overlap error of the displayed image and actual road image, so that the driver may obtain intuitively with his eyes the relative distance to the vehicle in front, width of the traffic lane, and routes available to be taken.

In order to achieve the above-mentioned objective, the present invention provides a vehicle image display system and correction method thereof, disposed in a vehicle, comprising at least: a first image fetching unit, an image processing unit, a projector unit, and a motor control unit. The image processing unit is connected electrically to the first image fetching unit, the projector unit, and the motor control unit. In the descriptions mentioned above, the first image fetching unit fetches at least an image of the road in front, then the image processing unit obtains positions of a lane marking and an obstacle in front based on the image of the front road. Then, after correction, it calculates the display information of positions of a lane marking and obstacles in front to be overlapped on the image of the actual road, and its generates a control signal and an alarm signal based on the dynamic motions of the driver. The projector unit projects the display information onto at least a viewable panel or windshield of the vehicle. The motor control unit is connected electrically to the image processing unit, the projector unit, and the viewable panel, and it adjusts the focal length or inclination angle of the projector unit, or the inclination angle of the viewable panel, based on the control signal from the image processing unit, to produce overlap error correction values to correct the display information.

The present invention also provides a vehicle image display system correction method, that is used in a vehicle to display vehicle driving information, comprising the following steps: fetch at least a front road image; obtain positions of a lane marking and an obstacle in front based on the front road image, and convert them into display information, so that this information is overlapped completely with image of the actual road, so the driver can determine intuitively if the vehicle has deviated from the traffic lane, if the vehicle is too close to the vehicle in front, and the routes available to be taken. Then the display conditions of the display information are used to generate overlap error correction values. The display conditions for example can be to adjust the focal length or inclination angle of a projector unit to produce the overlap error correction values, and the display condition can also be to adjust the inclination angle of the viewable panel to produce the overlap error correction values. In this respect, the projector unit or viewable panel or both can be adjusted manually or automatically depending on actual requirements, so as to correct the display information based on the overlap error correction values. Finally, project the display information onto at least a viewable panel or windshield of the vehicle, hereby presenting the complete display information of low error rate.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of a Head Up Display (HUD) according to the prior art;

FIG. 2 is a system block diagram of a vehicle image display system according to the present invention;

FIG. 3 is a flowchart of the steps of a vehicle image display system correction method according to the present invention;

FIG. 4 is a schematic diagram of multi coordinates conversion according to the present invention;

FIG. 5a is a schematic diagram of display information before correction; and

FIG. 5b is a schematic diagram of display information after correction.

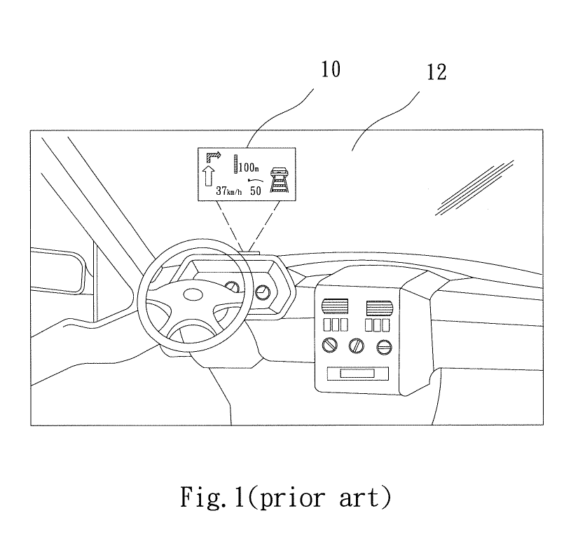

### DETAILED DESCRIPTION OF THE PREFERRED EMBODIMENT

The purpose, construction, features, functions and advantages of the present invention can be appreciated and understood more thoroughly through the following detailed description with reference to the attached drawings.

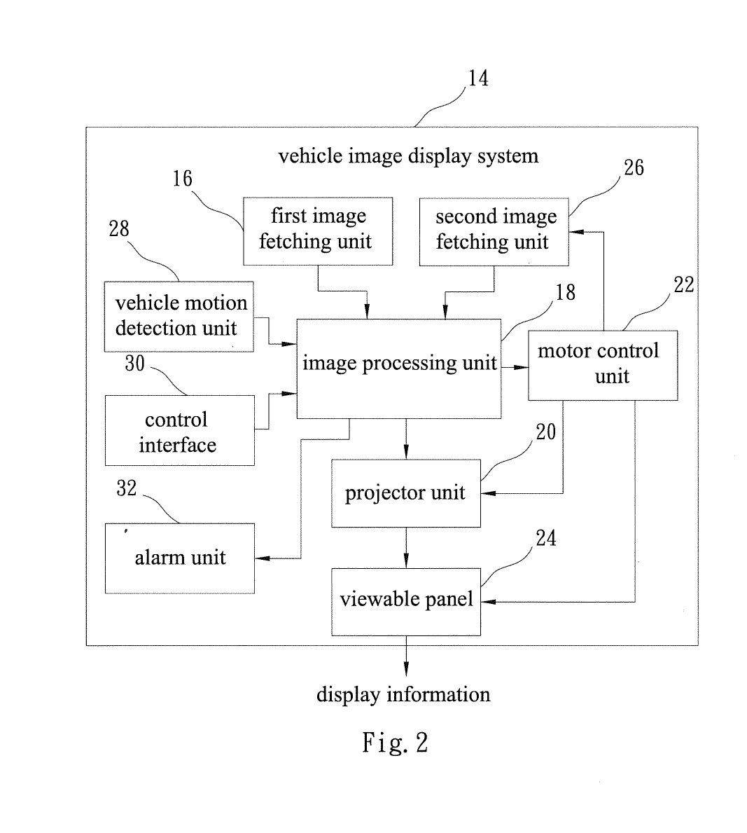

The present invention provides a vehicle image display system and correction method thereof, with its major objective of assisting the driver to have a complete grasp of the vehicle driving information in raising driving safety. Refer to FIG. 2 for a system block diagram of a vehicle image display system according to the present invention. As shown in FIG. 2, the vehicle image display system is installed in a vehicle, comprising: at least a first image fetching unit 16, an image processing unit 18, a projector unit 20, a motor control unit 22, and at least a viewable panel 24. The first image fetching unit 16 is connected electrically to the image processing unit 18, and the first image fetching unit 16 can be a Charge Coupled Device (CCD) sensor unit, a Complementary Metal Oxide Semiconductor (CMOS) sensor unit, or Infrared Image Fetching Device, installed in the windshield 25 of the vehicle to fetch at least a front road image. The image processing unit 18 recognizes the vehicle driving information based on the front road image, to obtain the positions of a lane marking and an obstacle in front, such as a vehicle in front, then it utilizes a correction coordinate conversion model (to be described later) to correct the positions of the lane marking and the obstacle in front, so as to calculate a display information about the positions of the lane marking and the obstacle in front, to be overlapped with image of actual traffic lane, and then generate a control signal. Of course, the display information can be virtual display information or real display information.

The viewable panel 24 can be a reflective optical film, disposed between windshield 25 and the projector unit 20, such that the display information is projected onto the viewable panel 24 or the windshield 25 by the projector unit 20. The projector unit 20 can be a projecting optical machine, provided with a focus varying system. Upon converting the image fetched by the first image fetching unit 16 into the display information, the information thus obtained can not be overlapped completely with image of actual road, due to different prevision points of the driver, or different image fetching and projecting positions. In this situation, image processing unit 18 may correct automatically the display information. For example, the image processing unit 18 can output a control signal of adjusting display conditions to the motor control unit 22. The motor control unit 22 is connected electrically to the image processing unit 18, the projector unit 20, and the viewable panel 24. Then, the motor control unit 22 adjusts the focal length or inclination angle of the projector unit 20, or the inclination angle of the viewable panel 24 based on the control signal from the image processing unit 18, to produce an overlap error correction value to correct the display information, thus achieving the effect of complete overlapping of the display information with the image of actual road. So, the driver may concentrate his attention to grasp intuitively the vehicle driving information, to ensure driving safety.

In the prior art, the image fetching device can be installed in different types of vehicles, such that the image fetching areas may be different along with different positions of the image fetching device, so that the installation people have to make frequent adjustments in causing great inconvenience. Moreover, human error of installation people in installing the image fetching device may reduce its recognition capability. In order to overcome this deficiency, the present invention provides an approach capable of adjusting the first image fetching unit 16 manually or automatically, so that in fetching the front road image, the image fetched can meet the requirement of the alarm system. By way of example, in case the vehicle is driven to a specific location, the image processing unit 18 may adjust the parameters of the first image fetching unit 16 automatically based on the parameters of the specific location, to obtain the altitude, inclination angle, distance, positions of the first image fetching unit 16. As such, reducing the risk of lowering recognition rate, and the inconvenience of repeated adjustments of the image fetching unit.

In the description above, the vehicle image display system 14 further includes at least a second image fetching unit 26, connected electrically to the image processing unit 18, and the motor control unit 22. The second image fetching unit 26 is preferably placed in front of the driver seat of the vehicle, to fetch images of driver's dynamic motions, such as those of driver's head and eyes. Then, the image processing unit 18 calculates the prevision point of the driver based on his dynamic motions, to output a control signal to the motor control unit 22, for it to control the inclination angle of the second image fetching unit 26, to be compatible with the prevision point of the driver, thus ensuring the accuracy of the display information.

Wherein, the vehicle image display system 14 further includes a vehicle motion detection unit 28, connected electrically to the image processing unit 18. The vehicle motion detection unit 28 is used to detect the vehicle driving information, such as driving speed, vehicle deviation amount, or steering wheel turning direction of the vehicle, and the image processing unit 18 calculates to obtain a prevision point of the driver according to the vehicle driving information. Then, it outputs a control signal to the motor control unit 22, to adjust the focal length or inclination angle of the projector unit 20, or the inclination angle of the viewable panel 24, to produce an overlap error correction value to correct the display information. Finally, it projects the corrected display information about positions of lane marking and the obstacle in front, and the vehicle driving information, onto the viewable panel 24 or the windshield 25.

Wherein, the vehicle image display system 14 further includes a control interface 30 and an alarm unit 32, connected electrically to the image processing unit 18 respectively. The control interface 30 is used for manual control, for the driver to perform parameter setting. The image processing unit 18 outputs a control signal to the motor control unit 22 based on the set parameters, to adjust the focal length or inclination angle of the projector unit 20, or the inclination angle of the viewable panel 24; or control the first image fetching unit 16 to adjust its height, inclination angle, position, and distance automatically based on the set parameters. Then, based on the image recognition result and vehicle driving information, the image processing unit 18 determines if the distance between the vehicle and the obstacle in front is below a safety range, or if the vehicle condition is lower than a preset safety value, to determine if it will issue an alarm signal to the alarm unit 32, for it to send out a warning. For example, the alarm unit 32 can be combined with a buzzer, LEDs, voice broadcast to remind the driver in an audio-optical manner, or be combined with the projector unit 20 to display warning frames, to remind the driver of the incoming danger, and to prevent it from happening.

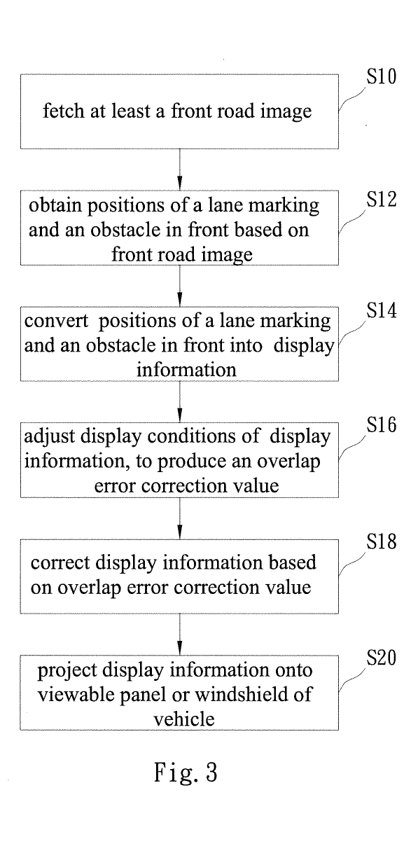

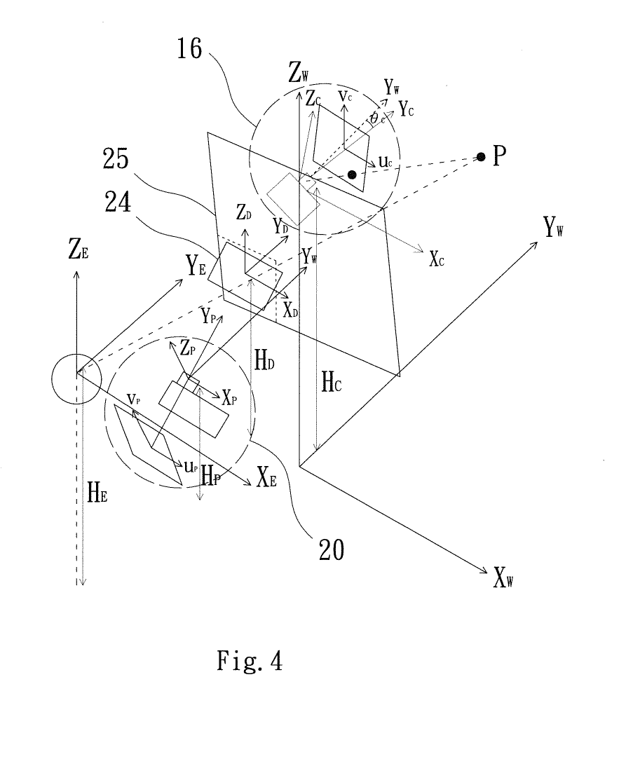

After describing the system structure as mentioned above, in the following, it is explained that a large area display information can be set up automatically, that can be overlapped entirely with images of the actual road. Refer to FIGS. 2 and 3 at the same time. FIG. 3 is a flowchart of the steps of a vehicle image display system correction method according to the present invention, which can be utilized in various types of vehicles. Therefore, upon activating the vehicle image display system 14, the image processing unit 18 determines that if it is in a first correction mode, for example, if the installation position, and inclination angle of the first image fetching unit 16, the projector unit 20, and the viewable panel 24 fulfill the ideal image fetching area and ideal projection display position of the corresponding vehicle type, in case the answer is negative, the image processing unit 18 performs corrections of the first image fetching unit 16, the projector unit 20, and the viewable panel 24 based on preset correction parameter values; otherwise start executing step S10, utilize the first image fetching unit 16 to fetch at least a front road image, wherein, in order to fetch all-weather images, the first image fetching unit 16 can be an infrared image fetching unit (for example, an infrared camera). Next, as shown in step S12, the image processing unit 18 obtains positions of a lane marking and an obstacle in front, based on a front road image. Subsequently, as shown in step S14, the image processing unit 18 utilizes a correction coordinate conversion model to convert the positions of traffic lane and obstacle in front into display information. Also, refer to FIG. 4 for a schematic diagram of multi coordinates conversion according to the present invention. Wherein, the correction coordinate conversion model can be described with the following formulae (1) and (2):

$$\begin{matrix}[ \begin{matrix}{u}_{p} \\ {v}_{p} \\ 1\end{matrix} ] = t \times {A}_{p} [ \begin{matrix}{R}_{EP 3 \times 3} & {T}_{EP 3 \times 1} \\ {0}_{3 \times 1} & 1\end{matrix} ] [ \begin{matrix}{R}_{W E 3 \times 3} & {T}_{W E 3 \times 1} \\ {0}_{3 \times 1} & 1\end{matrix} ] [ \begin{matrix}{X}_{W} \\ {Z}_{W} \\ {Y}_{W} \\ 1\end{matrix} ] & ( 1 ) \\ \{ \begin{matrix}{X}_{W} = \frac{{u}_{c} {H}_{c}}{{e}_{{v}_{c}} {m}_{{θ}_{c}} - {v}_{c}} \cdot \frac{{e}_{{v}_{c}}}{{e}_{{u}_{c}}} \\ {Y}_{W} = \frac{{e}_{{v}_{c}} {H}_{c}}{{e}_{{v}_{c}} {m}_{{θ}_{c}} - {v}_{c}} \\ {Z}_{W} = \frac{{m}_{{θ}_{c}} {e}_{{v}_{c}} {H}_{c}}{{e}_{{v}_{c}} {m}_{{θ}_{c}} - {v}_{c}}\end{matrix} & ( 2 )\end{matrix}$$

Wherein uₚ is u coordinate (horizontal coordinate) of the projector unit 20, vₚ is the v coordinate (vertical coordinate) of the projector unit 20, m_{θc} is an inclination slope of the first image fetching unit 16 (θc is the angle between the first image fetching unit 16 and the ground), H_{c} is the distance to ground of the first image fetching unit 16, u_{c} is the image plane u coordinate (horizontal coordinate) of the first image fetching unit 16, v_{c} is the image plane v coordinate (vertical coordinate) of the first image fetching unit 16, e_{uc} is the u focal length of the first image fetching unit 16, namely the distance from lens of the first image fetching unit 16 to image plane u axis, e_{vc} is the v focal length of the first image fetching unit 16, namely the distance from lens of the first image fetching unit 16 to image plane v axis, t is a parameter of driver vision line,

$$t = \frac{- d}{a {P}_{{X}_{E}} + b {P}_{{Y}_{E}} + c {P}_{{Z}_{E}}} ,$$

wherein a, b, c, d are parameters of a display plane D, namely parameters of a viewable panel 24 (as shown in FIG. 4, X_{D}, Y_{D}, Z_{D} are coordinates of viewable panel), or windshield 25 of the vehicle, P_{X}_{_{E}}, P_{Y}_{_{E}}, P_{Z}_{_{E}} are position of point P in human eye coordinates (X_{E}, Y_{E}, Z_{E}), (X_{W}, Y_{W}, Z_{W}) are universal coordinates, A_{P} is internal parameter of projector unit 20 (for example projection image focal section, optical axis center position), T_{WE3x} is a displacement matrix from the universal coordinates (X_{W}, Y_{W}, Z_{W}) to the human eye coordinates (X_{E}, Y_{E}, Z_{E}) T_{EP3x1} is a displacement matrix from human eye coordinates (X_{E}, Y_{E}, Z_{E}) to coordinates (X_{P}, Y_{P}, Z_{P}) of the projector unit 20, R_{WE3x3} is the rotation matrix from the universal coordinates (X_{W}, Y_{W}, Z_{W}) to the human eye coordinates (X_{E}, Y_{E}, Z_{E}) R_{EP3x3} is a rotation matrix from the human eye coordinates (X_{E}, Y_{E}, Z_{E}) to the coordinates (X_{P}, Y_{P}, Z_{P}) of projector unit 20.

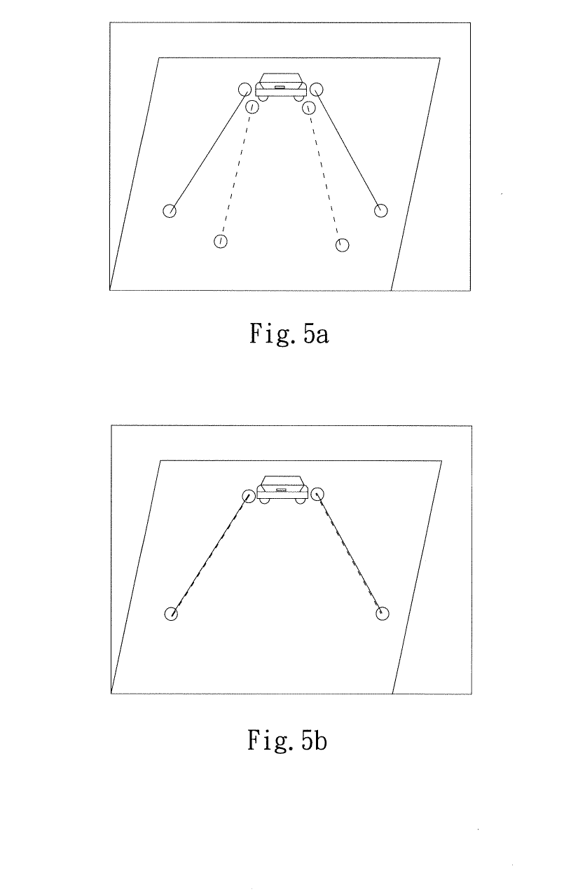

After utilizing the correction coordinate conversion model to convert positions of lane marking and obstacle in front to the display information, then, as shown in step S16, adjust the display conditions of display information, to generate an overlap error correction value. Wherein, the display conditions can be adjusting the focal length (for example parameter A_{P}) or inclination angle of the projector unit 20. More specifically, the adjusting steps of the projector unit 20 may use the coordinate values on the upper left, lower left, upper right, and lower right corners of a traffic lane of the display information, as shown in FIG. 5a, and substitute them into formulae (1) and (2) above, to calculate the overlap error correction value of the adjusted inclination angle. Then, as shown in step S18, correct the display information based on the overlap error correction value. Finally, as shown in step S20, after correction, calculate the display information about the positions of lane marking and obstacle in front to be overlapped with image of the actual traffic lane, then, the projector unit 20 projects the display information onto a viewable panel, as shown in FIG. 5b, so that visually, what the driver sees is as though the vehicle is in the actual lane marking and obstacle in front with their positions clearly marked, to help the driver to concentrate his attention on the field of view required.

In the descriptions mentioned above, the display conditions can also be adjusting the inclination angle of the viewable panel 24 to produce the overlap error correction values, then execute steps S18 to S20, to correct the display information with the overlap error correction values, and then project and display the corrected display information.

In addition, fine tune and minute correction of the display information can be performed real-time for the projector unit 20 and the viewable panel 24 at the same time. By way of example, the projector unit 20 may utilize the vehicle driving information such as the vehicle driving speed, vehicle deviation amount, or the steering wheel turning direction detected by the vehicle motion detection unit 28, to calculate the prevision point of the driver, and to adjust the focal length such as the switching of field depth vision angle, or inclination angle adjustment of the projector unit 20 through motor control unit 22, so that the driver may see more clearly the projection information displayed and the actual driving information, to effectively raise the driver's recognition of the actual road conditions and ensure driving safety. Meanwhile, the viewable panel 24 can be operated in cooperation with the second image fetching unit 26 to perform adjusting. For example, the viewable panel 24 is able to calculate the prevision point of the driver based on the information about head and eye dynamic motion of the driver, as fetched by the second image fetching unit 26, and then the inclination angle of the viewable panel 24 is adjusted through utilizing the motor control unit 22. As such, in the present invention, the adjustment can be achieved through cooperation of hardware and software, so that the display information can be overlapped entirely with the actual road image, thus it can not only raise vehicle driving safety, but it can also overcome the shortcomings of the prior art that image correction can only be performed through software, and it can not achieve large area projection display and precise image correction.

Summing up the above, the present invention integrates the vehicle driving information and the safety and alarm information into the display information, and projects it onto a viewable panel 24 through a projector unit 20. So visually, the driver feels that he is driving on the actual traffic lane, and the obstacle in front is clearly marked, such that the information is presented to the driver real-time for him to have a precise grasp of the actual road conditions to raise driving safety.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A vehicle image display system, installed in a vehicle, comprising:
at least a first image fetching unit, used to fetch at least a front road image;
an image processing unit, connected electrically to said first image fetching unit, used to obtain positions of a lane marking and an obstacle in front based on said front road image, and after correction, it calculates display information of said positions of said lane marking and said obstacle in front, to be overlapped on an image of an actual traffic lane, and generate a control signal and an alarm signal;
a projector unit, connected electrically to said image processing unit, used to project said display information onto at least a viewable panel or a windshield of said vehicle; and
a motor control unit, connected electrically to said image processing unit, said projector unit, and said viewable panel, said motor control unit adjusts focal length or inclination angle of said projector unit, or inclination angle of said viewable panel based on said control signal of said image processing unit, to generate an overlap error correction value to correct said display information.

2. The vehicle image display system as claimed in claim 1, wherein said viewable panel is a reflective optical film, disposed between said windshield and said projector unit.

3. The vehicle image display system as claimed in claim 1, further comprising:
at least a second image fetching unit, connected electrically to said image processing unit, said second image fetching unit obtains dynamic motions of a driver, said image processing unit calculates a prevision point of said driver based on said dynamic motion, to output said control signal to said motor control unit.

4. The vehicle image display system as claimed in claim 1, further comprising:
a vehicle motion detection unit, connected electrically to said image processing unit, said vehicle motion detection unit detects vehicle driving information of said vehicle, said image processing unit calculates a prevision point of said driver based on said vehicle driving information, to output said control signal to said motor control unit, and project said vehicle driving information onto said viewable panel and said windshield.

5. The vehicle image display system as claimed in claim 1, wherein said image processing unit utilizes a correction coordinate conversion model to correct said positions of said lane marking and said obstacle in front, and to calculate said display information of said positions of said lane marking and said obstacle in front to be overlapped on image of said actual traffic lane.

6. The vehicle image display system as claimed in claim 1, further comprising:
a control interface, connected electrically to said image processing unit, for user to set parameters, said image processing unit outputs said control signal to said motor control unit based on said parameters, for adjusting focal length or inclination angle of said projector unit, or inclination angle of said viewable panel, or said image processing unit controls said first image fetching unit based on said parameters, to adjust automatically parameters of its height, inclination angle, position, and distance.

7. A vehicle image display system correction method, applicable to a vehicle to perform vehicle information display and issue vehicle safety alarm, comprising following steps:
fetch at least a front road image;
obtain positions of a lane marking and an obstacle in front based on said front road image;
convert said positions of said lane marking and said obstacle in front into display information;
adjust display conditions of said display information, to produce an overlap error correction value;
correct said display information based on said overlap error correction value; and
project said display information onto said viewable panel.

8. The vehicle image display system correction method as claimed in claim 7, wherein said front road image is fetched by said first image fetching unit, and an image processing unit controls said first image fetching unit to calibrate automatically its parameters based on calibration parameters of at least a preset location, to obtain automatically corrected parameters of altitude, inclination angle, position, and distance of said first image fetching unit.

9. The vehicle image display system correction method as claimed in claim 7, wherein said display condition is to adjust said focal length or inclination angle of said projector unit, to produce said overlap error correction values, or to adjust inclination angle of said viewable panel, to produce said overlap error correction values.

10. The vehicle image display system correction method as claimed in claim 9, wherein said adjusting step of said projector unit is to calculate said overlap error correction values of inclination angle based on said display information of upper left, lower left, upper right, and lower right corners of said traffic lane, or to calculate said overlap error correction values of inclination angle based on said prevision point of a driver; and said adjusting step of said viewable panel is to calculate said overlap error correction values of inclination angle based on said prevision point of said driver.
